(19) United States
(12) Patent Application Publication
(10) Pub. No.: US 2025/0233737 A1
(43) Pub. Date: Jul. 17, 2025

(54) System and Method for Securing Transactions Using Quantum Entanglement Verification and Scalable Photon Transmission Network

(71) Applicant: Edward Starrs, FOLSOM, CA (US)

(72) Inventor: Edward Starrs, FOLSOM, CA (US)

(21) Appl. No.: 19/087,242

(22) Filed: Mar. 21, 2025

(51) Int. Cl. H04L 9/08; G06N 10/70

(52) U.S. Cl. CPC H04L 9/0855; G06N 10/70

(57) ABSTRACT

A system and method to secure transactions in finance, banking, and communications using quantum entanglement for authentication. A trusted authority generates entangled photon pairs, distributed via a scalable network with quantum repeaters, fiber optics, and satellites. Entanglement verification ensures transaction integrity, with multi-wavelength multiplexing and error correction enhancing this physics-based solution's scalability and reliability.

### BACKGROUND

### Field

This invention relates to secure transaction processing using quantum entanglement across multiple domains, supported by a photon transmission network.

### Related Art

Traditional cryptography (e.g., RSA) is vulnerable to quantum computing. Quantum key distribution (QKD) secures keys but not transactions directly. No known system combines entanglement verification with a scalable, multi-use network as described herein.

### SUMMARY

The Quantum Entanglement Transaction Security (QETS) system authenticates transactions via quantum entanglement. Entangled photons are generated, distributed through a scalable network, and verified at endpoints. Key features include quantum repeaters with multi-memory arrays, error correction, and broad applications (e.g., voting, IoT), offering a scalable, physics-based security solution.

### BRIEF DESCRIPTION OF DRAWINGS

FIG. 1: Block diagram of QETS system (entanglement source, network, endpoints).

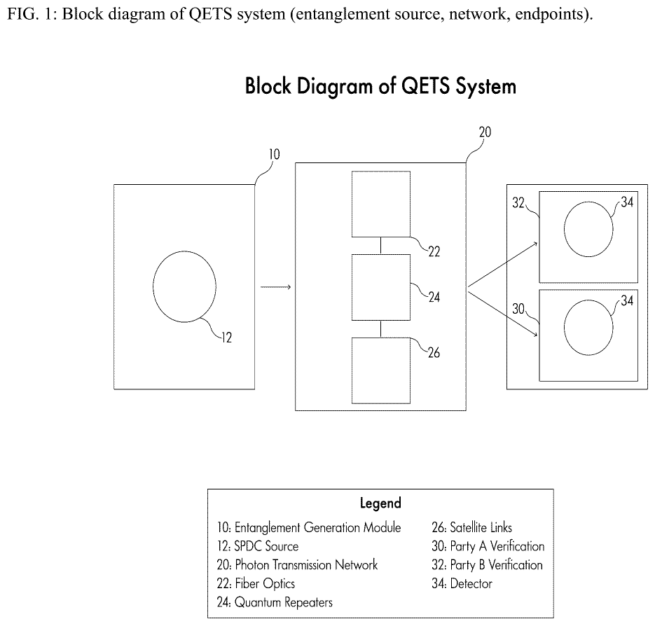

FIG. 2: Flowchart of transaction verification with entanglement swapping.

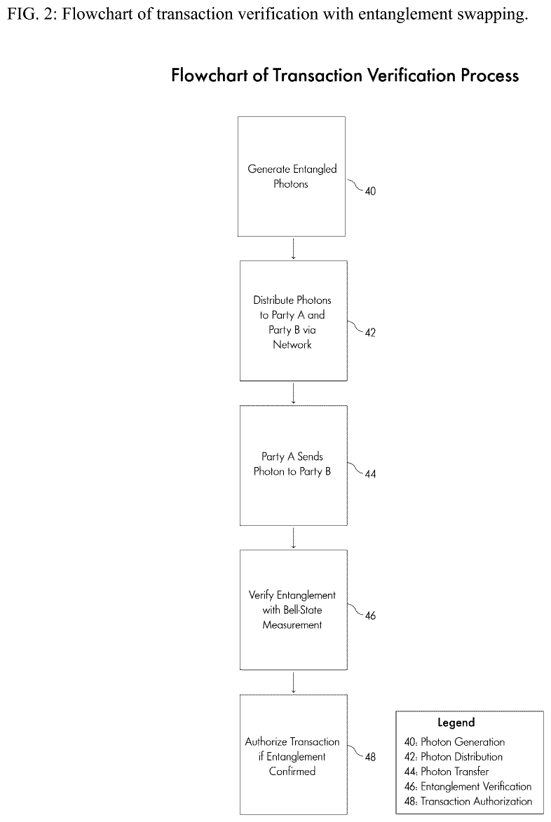

FIG. 3: Network schematic (hubs, repeaters, satellites).

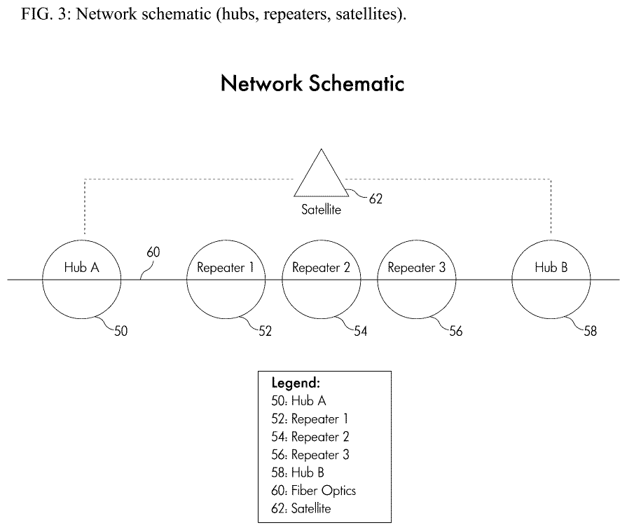

FIG. 4: Quantum repeater with multi-memory and Bell-state measurement components.

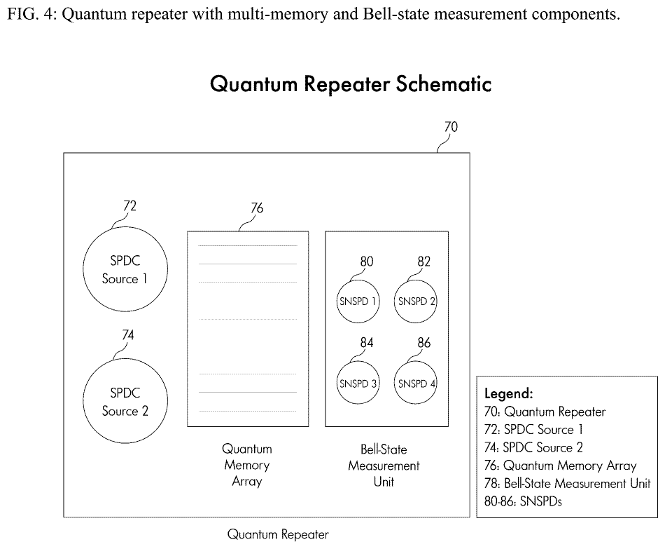

### DETAILED DESCRIPTION

### System Components

Entanglement Generation Module: Uses spontaneous parametric down-conversion (SPDC) to produce entangled photon pairs at 1550 nm, with multi-wavelength multiplexing for high output (˜10⁸ pairs/s).

### Photon Transmission Network

Centralized hubs with high-capacity sources.
Fiber optic channels (<0.2 dB/km loss).
Quantum repeaters: Dual SPDC sources, 10-100 quantum memories (e.g., Tm³⁺:LiNbO₃), four SNSPDs for Bell-state measurement, 4 K cooling.
Satellite links with adaptive optics.

End-User Verification Module: Photonic chips with SNSPDs and quantum error correction (e.g., surface codes).

Control System: AI-driven routing, pre-distribution to quantum memories.

### Method

1. Generate entangled photons.
2. Distribute via network, using repeaters for >100 km.
3. Party A sends photon to Party B for entanglement verification.
4. Authorize transaction if verified, applying error correction.

### EXAMPLE

A $1,000 online purchase: Payment processor distributes photons over 500 km via three repeaters. Seller verifies entanglement in 5 ms, completing the transaction.

1. A system for securing transactions, comprising: an entanglement generation module producing entangled photon pairs across multiple wavelengths; a photon transmission network distributing said photons to a first party and a second party, including quantum repeaters with multi-memory arrays; a verification module confirming entanglement with quantum error correction; a control system authorizing transactions upon verification.

2. The system of claim 1, wherein the entanglement generation module uses multi-wavelength multiplexing for at least 10⁸ pairs per second.

3. The system of claim 1, wherein each quantum repeater includes dual entanglement sources, an array of at least ten quantum memories, and a Bell-state measurement unit with four detectors.

4. The system of claim 1, wherein the network combines fiber optics and satellite links.

5. The system of claim 1, wherein transactions include financial transfers, banking, communications, voting, or IoT authentication.

6. A method for securing a transaction, comprising: generating entangled photons; transmitting them to a first and second party via a network with quantum repeaters; receiving the first photon at the second party; verifying entanglement with error correction; authorizing the transaction.

7. The method of claim 6, wherein repeaters swap entanglement across 50-200 km segments. dynamically adjusted.

8. The method of claim 6, including pre-distributing photons to quantum memories.

9. The method of claim 6, using multiple wavelengths for increased capacity.
